(19) United States
(12) Patent Application Publication
(10) Pub. No.: US 2022/0014526 A1
(43) Pub. Date: Jan. 13, 2022

(54) MULTI-LAYER BIOMETRIC AUTHENTICATION

(71) Applicant: Bank of America Corporation, Charlotte, NC (US)

(72) Inventors: Patrick Burgess, Chicago, IL (US); Robert S. Mumma, Chicago, IL (US); Trish Gillis, Chicago, IL (US)

(21) Appl. No.: 16/924,315

(22) Filed: Jul. 9, 2020

(51) Int. Cl. H04L 29/06; H04L 9/32

(52) U.S. Cl. CPC H04L 63/105; H04L 63/0861; H04L 2463/082; H04L 9/3228; H04L 9/3213; H04L 9/3231

(57) ABSTRACT

Apparatus and methods for generating secure electronic document authentication are provided. Authentication may include formulating “electronic signatures” or any other validation of electronic information. Apparatus and methods may include capturing a target biometric feature to authenticate the electronic information. The target biometric feature may include a combination or sequence of biometric features. In some embodiments, the target biometric feature may be captured without specially prompting a user to submit a biometric feature. A captured target biometric feature may be augmented by generation of a one-time-password using a token stored locally on a mobile device. Authentication processes described herein provide more secure, accurate authentication for electronic information.

### FIELD OF TECHNOLOGY

Aspects of the disclosure relate to technology for improving authentication of information using a computer system.

### BACKGROUND

An entity may require authentication of electronic information. One example of electronic information requiring authentication may include a HIPAA (Health Insurance Portability and Accountability Act) release. After authenticating a HIPAA release, a user may authorize sharing and release of medical information. Another example of an electronic information is documentation for financial services or products that are not Federal Deposit Insurance Corporation (FDIC) insured and may lose value. Upon authenticating the electronic information, the user may confirm that they to obtain the desired financial services or products even though they may not be FDIC insured and may lose value.

Typically, a conventional authentication process may include a user viewing electronic information on a computer system. However, current technological solutions for electronically signing or otherwise authenticating the displayed electronic information are cumbersome and unsecure. For example, a user may be required to manually sign or type initials to authentication the displayed electronic information. Such conventional authentication methods are also susceptible to being spoofed or forged.

It would be desirable to provide systems and methods for more securely and accurately authenticating electronic information. Accordingly, it would be desirable to provide apparatus and methods for MULTI-LAYER BIOMETRIC AUTHENTICATION.

### BRIEF DESCIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative system in accordance with principles of the disclosure;

FIG. 2 shows an illustrative system in accordance with principles of the disclosure;

FIG. 3 shows an illustrative scenario and apparatus in accordance with principles of the disclosure;

FIG. 4 shows an illustrative apparatus and scenario in accordance with principles of the disclosure;

FIG. 5 shows an illustrative apparatus and scenario in accordance with principles of the disclosure; and

FIG. 6 shows an illustrative apparatus and scenario in accordance with principles of the disclosure.

### DETAILED DESCRIPTION

Apparatus for authenticating electronic information are provided. The electronic information may be a document that requires authentication by a user of a mobile device. The user may be an eligible authenticator of the electronic information. The terms “user” and “authenticator” may be used interchangeably herein. For example, electronic information may include a contract or other legal instrument. The apparatus may include a device that includes hardware that displays the information. The device may be a mobile device such as a smartphone or laptop computer. The device may include a touch-sensitive screen. The touch-sensitive screen may be responsive to a user's finger motions applied to a surface of the touch-sensitive screen. The device may be any suitable computer system.

An illustrative computer system may be a network connected computer system. Computer systems, as disclosed herein, may include a processor circuit. The processor circuit may control overall operation of the computer system and its associated components. The processor circuit may include hardware, such as one or more integrated circuits that form a chipset. The hardware may include digital or analog logic circuitry configured to perform any suitable (e.g., logical) operation.

For example, a computer system may include one or more of the following hardware components: I/O circuitry, which may include a transmitter device and a receiver device and may interface with fiber optic cable, coaxial cable, telephone lines, wireless devices, physical network layer hardware, a keypad/display control device or any other suitable encoded media or devices; peripheral devices, which may include counter timers, real-time timers, power-on reset generators or any other suitable peripheral devices; a logical processing device, which may compute data structural information, structural parameters of the data, or quantify indices; and machine-readable memory.

Machine-readable memory may be configured to store, in machine-readable data structures: machine learning algorithms, artificial intelligence algorithms, or any other suitable information or data structures. Components of the computer system may be linked by a system bus, wirelessly or by other suitable interconnections. System components may be present on one or more circuit boards. In some embodiments, the components may be integrated into a single chip. The chip may be silicon-based.

The computer system may include RAM, ROM, an input/output (“I/O”) module and a non-transitory or non-volatile memory. The I/O module may include a microphone, button and/or touch screen which may accept user-provided input. The I/O module may include one or more of a speaker for providing audio output and a video display for providing textual, audiovisual and/or graphical output.

Software applications may be stored within the non-transitory memory and/or other storage medium. Software applications may provide instructions to the processor that enable the computer system to perform various functions. For example, the non-transitory memory may store software applications such as an operating system, application programs, and an associated database. Some or all of computer executable instructions of the computer system may be embodied in hardware or firmware components of the computer system.

The computer system may include cloud computing and virtualization implementations of software. Such implementations may be designed to run on a physical computer system supplied externally by a hosting provider, a client, or other virtualized platform.

Software application programs, which may be used by the computer system, may include computer executable instructions for invoking user functionality related to communication, such as email, short message service (“SMS”), and voice input and speech recognition applications. Software application programs may utilize one or more algorithms that formulate predictive machine responses, formulate database queries, process human caller inputs, process human agent inputs, or any other suitable tasks.

A computer system may include a communication circuit. The communication circuit may include a network interface card or adapter. When used in a WAN networking environment, apparatus may include a modem, antenna or other circuitry for establishing communications over a WAN, such as the Internet. The communication circuit may include a modem and/or antenna. The existence of any of various well-known protocols such as TCP/IP, Ethernet, FTP, HTTP and the like is presumed, and the computer system may be operated in a client-server configuration to permit retrieval of web pages from a web-based server. Web browsers can be used to display and manipulate data on web pages.

A computer system may include various other components, such as a display, battery, speaker, and antennas. Network connected systems may be portable devices such as a laptop, tablet, smartphone, other “smart” devices (e.g., watches, eyeglasses, clothing having embedded electronic circuitry) or any other suitable device for receiving, storing, transmitting and/or displaying electronic information.

A computer system may include, and may be operational with, numerous other general purpose or special purpose computing system environments or configurations. Examples of well-known computing systems, environments, and/or configurations that may be suitable for use with this disclosure include, but are not limited to, personal computers, server computers, handheld or laptop devices, tablets, mobile phones, multiprocessor systems, minicomputer systems, microprocessor systems, mainframe computers, distributed computing environments that include any of the above systems or devices, and the like.

A computer system may utilize computer-executable instructions, such as program modules, executed by a processor.

Generally, program modules include routines, programs, objects, components, data structures, etc. that perform particular tasks or implement abstract data types. A computer system may be operational with distributed computing environments where tasks are performed by remote processing devices that are linked through a communications network. In a distributed computing environment, program modules may be located in both local and remote computer storage media including memory storage devices. A computer system may rely on a network of remote computer systems hosted on the Internet to store, manage, and process data (e.g., “cloud computing” and/or “fog computing”).

Computer systems disclosed herein may be produced by different manufacturers. For example, the user may receive the electronic information from a first computer system. The user may authenticate the documents and push the authenticated document to a second computer system for storage. Computer systems may capture data in different formats. Computer systems may use different data structures to store captured data. Each computer systems may utilize different communication protocols to transmit captured data or communicate with other computer systems. Despite such operational differences, computer systems may be configured to operate substantially seamlessly to interact with each other to authenticate electronic information.

The device may include a software application. The application may generate a one-time password (“OTP”) using a token stored on the device. The token may be tethered to the device. The token may only generate the OTP when the token resides on the tethered device.

The OTP may be submitted to a remote computer system for validation. The remote computer system may confirm that the generated OTP was in fact generated using a token resident on the tethered device. The remote computer system may locate electronic information that needs to be authenticated by a user of the device. After successful validation of the OTP, the application may obtain electronic information from the remote computer system that needs to be authenticated by the user of the device. After successful validation of the OTP, electronic information received from the remote computer system may be displayed on the device. In response to receiving the electronic information from the remote computer system, the application may initiate an authentication process for the received information.

The authentication process may include formatting electronic information for display on the device. Such formatting may include changing operation of the device to display the received electronic information. The formatting may include changing operation of the of the device to display the received electronic information based on a content of the electronic information.

The change in operation may include altering a luminosity of a screen of the device, altering the size of text characters displayed on the screen of the device, rearranging the electronic information and temporally terminating communication between the device and any other computer system. Terminating communication between the device and any other computer system may reduce a possibility of unauthorized authentication being affixed to the electronic information.

The change in operation may include formulating digital identifiers or flags indicating sections of the electronic information that need to be authenticating by a user of the device. For example, illustrative electronic information may include multiple sections. Each section may need to be authenticated by a different user. When the electronic information is received by a target user, the application may highlight or otherwise indicate sections that need to be authenticated by the target user.

The application may activate a biometric sensor of the device. A biometric sensor may capture biometric features such as fingerprints, facial recognition, iris recognition, speech recognition, hand geometry, DNA or signature verification. A biometric sensor may include a transducer that converts an observed biometric feature into an electrical signal. Biometric sensors may capture light, temperature, speed, electrical capacity and other types of inputs.

A biometric sensor may capture physiological biometric features. Physiological biometric features may include fingerprints, facial recognition and iris recognition. A biometric sensor may capture behavioral biometric features. Behavioral biometric features may include keystrokes, signature and voice recognition.

The application may activate the biometric sensor after formatting the electronic information for display on the device. A device may include two or more biometric sensors. Each biometric sensor may include hardware and software for capturing a target biometric feature. For example, a device may include a fingerprint reader, an iris scanner and facial recognition technology.

The activated biometric sensor may be determined based on content of the electronic information. For example, if the electronic information includes sensitive content, a biometric sensor for a more secure biometric feature may be activated. As a further example, for particularly sensitive information, two or more biometric sensors may be activated. The user may be required to submit a combination of biometric features to authenticate electronic information.

The biometric sensor activated by the application may be determined based on how the electronic information is formatted on the device. For example, the device may include a fingerprint reader embedded within, or underneath the screen. The user may authenticate information by submitting a fingerprint using the embedded fingerprint reader. The device may confirm whether the provided fingerprint matches a known electronic signature of a fingerprint securely stored locally on the device. In some embodiments, the device may submit the captured fingerprint to remote computer system for verification.

The device may display the electronic information in a target area of the screen such that the information that needs to be authenticated is overlaid above or otherwise aligned with a biometric sensor such as a fingerprint reader. For example, by pressing a finger against the target area, the user may register authentication of the electronic information by touching the target area of the screen and simultaneously submitting a fingerprint for verification.

For each field of the information that requires authentication, the application may prompt the user for a target biometric feature. The target biometric feature requested may be determined based on reliability of the biometric, security of the biometric feature, sensitivity of the electronic information and/or a combination of biometric features needed to authenticate the information. The target biometric feature may be determined based on a capability of the device to capture one or more biometric features. The target biometric feature may be determined by a creator or system that originates the electronic information.

A target biometric feature may include two or more biometric features. For example, the target biometric feature may require that the user submit a combination of biometric features to authenticate the information. The application may determine the combination of required biometric features based on a sensitivity of the information, location of the device, authority of the user, transaction history of the user or any suitable criteria.

A target biometric feature may include a sequence of biometrics features. The sequence may include a combination of biometric features that must be submitted in a specific order. The sequence may depend on a sensitivity of the information. The application may determine a new sequence of biometric features each time a user is asked to authenticate information. The application may generate a randomized sequence of biometric features each time authentication is requested. The sequence may be determined based on a location of the user. For example, if the user is outside a usual location, the application may require a longer sequence of biometric features.

The sequence may require submitting the same biometric feature two or more times. For example, an illustrative sequence may require the user submit the following biometric features in the specified order: (1) right index fingerprint; (2) facial scan; (3) left thumbprint; (4) right index fingerprint. The application may randomize the sequence for each instance of authentication. The varying nature of the sequence may enhance security and reliability of the authentication process.

The application may capture the target biometric feature submitted by the authenticator using the biometric sensor of the device. The application may validate the target biometric feature submitted by the authenticator. The application may authenticate the information by validating the captured target biometric feature. Validating a captured biometric feature may include determining whether an electronic signal of the captured biometric feature matches a stored electronic signal.

The application may authenticate the information using a combination of OTP validation and validation of a target biometric feature. The application may generate authentication for the information based on the captured and validated biometric feature. The application may embed the authentication in the information. Embedding the authentication in the electronic information may ensure that the authentication is always transferred along with the electronic information.

The application may determine a target biometric feature based on authenticator behavior. For example, the application may determine a biometric feature that is most convenient for the authenticator. For example, based on weather at a current location of the device, the application may determine that the authenticator is most likely wearing gloves and providing a fingerprint may be inconvenient. Therefore, the application may activate facial recognition technology, an iris scanner or utilize a combination of behavioral biometrics. In some embodiments, if the application may determine that requesting a hand-drawn signature is the most convenient authentication method.

The application may determine a target biometric feature based on capabilities of the device. Some devices may include fingerprint readers that do not obscure the display of electronic information. Other devices may not include an ability to process facial recognition. In some embodiments, if the device does not include the ability to natively validate a target biometric feature, the device may nonetheless capture behavioral or other information that may be later analyzed to validate a target biometric feature(s).

For example, a device may not include the ability to natively capture facial recognitions. However, the device may include a camera that is capable of capturing an image that may be later analyzing to validate facial features captured in the image. When the application determines that a facial recognition is needed to authenticate the information, the application may capture an image needed to validate facial features. The captured image may be submitted to a remote computer system to validate the facial features in the captured image.

The application may determine a target biometric feature for authenticating electronic information based on a current location of the device. For example, in a particular location, a biometric feature may be more difficult to accurately validate. For example, if the device is outside in bright sunlight, a facial feature may be difficult to validate. In such instances the application may request authentication based on two fingerprints.

As a further example, the application may determine that the user is in location that cannot accurately capture a voice pattern. For example, the user may be in a train station, airport or other location with high levels of background noise. Based on the detected location, the application may request an alternative biometric feature.

The application may, based on a detected location, determine one or more alternate biometric features that may be captured to authenticate the information. For example, a fingerprint or facial recognition may not be as reliable as voice pattern recognition. If the application detects that the current location is not conducive to capturing a voice pattern, the application may request a fingerprint and a facial recognition to authenticate the information.

The device may include at least two sensors for capturing biometric features. The application may activate the two or more biometric sensors simultaneously. The application may require that the user submit two or more biometric features together in real time. For example, the application may activate a fingerprint reader and a camera for capturing a facial scan. The application may require that the user provide the fingerprint scan and the facial scan simultaneously. Simultaneously may be defined as in “real-time.” Real-time refers to time during which a process or event occurs.

In some embodiments, the application may provide a time window for capturing the two or more biometric features. For example, the application may require a second biometric feature be submitted within 5 seconds of capturing a first biometric feature. The application may adjust the time window based on user behavior, sensitivity of the electronic information, a property of the requested biometric feature or any suitable criteria.

An authenticator may be a first authenticator. The device may be a first device. The target biometric feature may be a first target biometric feature. The authentication process may include determining biometric feature(s) for authenticating two or more fields of the electronic information. Each field of the information may be a clause of legal document that requires authentication from the authenticator. Different fields may require authentication from different authenticators. The authenticator and biometric feature needed to authenticate a particular field may be determined based on a content of the field. In some embodiments, two or more authenticators may be needed to authenticate a single field. In some embodiments, two or more biometric features may be needed to authenticate a single field.

The authentication process may include prompting a second authenticator for a second target biometric feature. The authentication process may capture a first biometric feature from a first user using a first device. The authentication process may capture a second biometric feature from a second user using a second device. The authentication process may validate the first target biometric feature submitted by the first authenticator. The authentication process may validate the second target biometric feature submitted by the second authenticator. The application may generate an authentication based on validating the first and second biometric feature received from the first and second authenticators.

After validating captured biometric features, the application may authenticate the information by embedding the authentication in the information. For added security, the authentication may also require generation of an OTP to complete the authentication process. An authentication based on a validated biometric feature may only be embedded in the information after an OTP is generated and validated.

When information includes two or more fields that require independent authentication by different users, the application may hide, from the first user, fields that need to be authenticated by a second user. The application may hide, from the second user, fields that need to be authenticated by the first user.

The authentication process may require a first target biometric feature for a first field of the information. The authentication process may require that the first target biometric feature be submitted by a first authenticator when at a first target location. The authentication process may require a second target biometric feature for a second field of the information. The authentication process may require that the second target biometric feature be submitted by a second authenticator when at a second target location.

Apparatus for authenticating electronic information is provided. The apparatus may include a device comprising hardware that displays the electronic information. The device may be a computer system, such as a smartphone or tablet. An application running on the device may configure display properties of the device for viewing a subset of the electronic information. The subset of electronic information may also be referred to herein as a field of the electronic information. The application may determine a target biometric feature for authenticating the subset of the electronic information. The target biometric feature may be determined based on content of the information, authority of an authenticator and capabilities of the device.

A target biometric feature may include two or more biometric features or a sequence of biometric features. A sequence may require a first authenticator to provide a valid target biometric feature before a subset of electronic information is made available for authentication to a second authenticator. The target biometric feature may be randomly selected by the application or remote computer system from a group of biometric features that are capable of being captured by the device.

The application may capture the target biometric feature from an authenticator to authenticate the subset of the electronic information. The application may validate the captured target biometric feature by comparing an electronic signature of a biometric feature captured by a sensor on the device to a stored electronic signature of a known biometric feature. The stored electronic signature may be stored locally on the device in a secure storage location. The stored electronic signature may be stored on a remote computer system.

After capturing the target biometric feature, the application may generate a one-time-password (“OTP”) using a token stored locally on the device. The OTP may authenticate the device to a remote system. In response to receiving validation of the OTP from the remote computer system, the application may generate a digital authentication for the subset of the electronic information using the captured target biometric feature. Validation of the OTP may confirm that the device that captured the target biometric feature is authorized to authenticate the subset of information.

The OTP may be a second OTP (“fOTP”) that is used to authenticate the displayed electronic information. The application may generate a first one-time password (“fOTP”). The application may generate the fOTP using the token stored on the device. Using the fOTP, the application may locate two or more subsets of the electronic information for display on the device. Based on validating the fOTP, each subset may be “unlocked” and presented for authentication on the device.

The application may then initiate an authentication process for each of the now unlocked subsets. The authentication process may determine a target biometric feature required to authenticate each of the unlocked subsets. The sOTP may be then be generated and used to authenticate the subset presented for authentication on the device in conjunction with a captured target biometric feature.

The device may be a first device. A subset of information may be a first subset. The remote system may be configured to coordinate authentication of a first subset of the electronic information using the first device and authentication of a second subset of the electronic information using a second device. The first and second devices may be under the control of different authenticators. The first device may generate a fOTP to access a first subset of electronic information. The second device may generate a sOTP to access a second subset of the electronic information.

In some embodiments, authentication from the first and second authenticators may collectively be required to authenticate a single subset of electronic information. The fOTP may provide the first authenticator access to the subset and the sOTP may provide the second authenticator access to the subset.

A target biometric feature requested by the remote computer system may be determined based on a capability of a device or device user. The application may require different biometric features from the first authenticator (using the first device) and the second authenticator (using the second device). The target biometric feature requested by the remote computer system may be determined based on content of the subset of electronic information presented for authentication.

Methods for validating electronic information are provided. Methods may include generating a one-time password (“OTP”) using a token stored on a device. The device may be a computer system such as a desktop computer, smartphone or tablet. In response to validating the OTP, methods may include displaying the electronic information on the device.

Methods may include optimizing the device for display of the electronic information. Such optimization may include altering luminosity of a screen on the device, altering the size of text characters displayed on the screen of the device, and temporally terminating communication between the device and any other computer system. Terminating communication between the device and any other computer system may reduce a possibility of unauthorized authentication being affixed to the electronic information.

Methods may include, as the electronic information is viewed on the device, capturing a biometric feature of the viewer. The capturing of the biometric feature may occur in substantially real-time with a viewing of the electronic information on the device. For example, while viewing the electronic information, methods may include capturing a facial scan of the authenticator. Methods may include authenticating the electronic information based on validating the captured biometric feature.

Methods may include determining a target biometric feature based on the OTP. Each OTP may be linked to specific device and user/authenticator. Methods may include determining the target biometric feature based on capabilities of the specific device or authority of the user. Methods may include capturing a target biometric feature before generating the OTP. Methods may include validating the captured target biometric feature before generating the OTP. Methods may include generating the OTP based on the validated target biometric feature in combination with the token stored on the device.

Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional and procedural modifications may be made without departing from the scope and spirit of the present disclosure.

The steps of methods may be performed in an order other than the order shown and/or described herein. Method embodiments may omit steps shown and/or described in connection with illustrative methods. Method embodiments may include steps that are neither shown nor described in connection with illustrative methods. Illustrative method steps may be combined. For example, an illustrative method may include steps shown in connection with any other illustrative method.

Apparatus may omit features shown and/or described in connection with illustrative apparatus. Apparatus embodiments may include features that are neither shown nor described in connection with illustrative apparatus. Features of illustrative apparatus may be combined. For example, an illustrative apparatus embodiment may include features shown or described in connection with another illustrative apparatus/method embodiment.

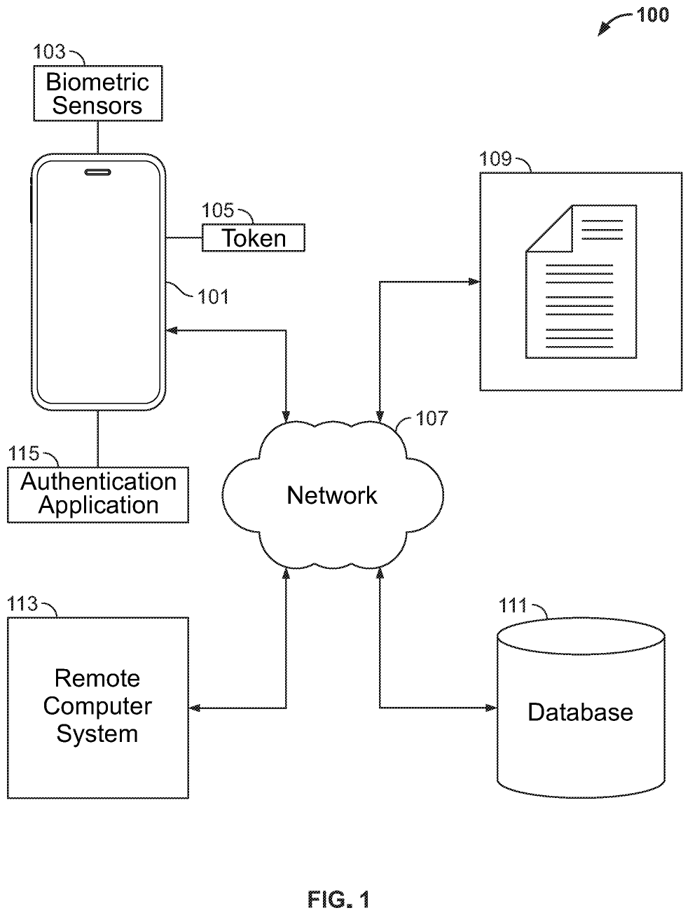

FIG. 1 shows illustrative system 100. System 100 includes mobile device 101. Mobile device 101 includes biometric sensors 103. Biometric sensors 103 may a convert a biometric feature into an electrical signal. Biometric features may include physical and/or behavioral features. Illustrative biometric features may include vein patterns, ear shape, tooth shape, walking gait, hand geometry, DNA, voice patterns, iris patterns, signature dynamics and face detection.

Mobile device 101 includes token 105. Token 105 may be stored locally on mobile device 101. Token 105 may generate an OTP. Token 105 may only generate the OTP when token 105 is stored on mobile device 101. Token 105 may not generate the OTP when stored on any other device or system.

The OTP may be used to authenticate mobile device 101 to remote computer system 113. In response to authenticating mobile device 101, remote computer system 113 may push electronic information 109 to mobile device 101 over network 107. Remote computer system 113 may instruct database 111 to allow mobile device 101 to access a copy of electronic information 109 stored in database 111.

After mobile device 101 obtains access to electronic information 109, authentication application 115 determines one or more subsets of electronic information 109 that need to be authenticated by mobile device 101. In some embodiments, remote computer system 113 may provide authentication requirements to authentication application 115. In some embodiments, electronic information 109 may include its own embedded authentication requirements. Authentication application 115 may be configured to extract authentication requirements from electronic information 109.

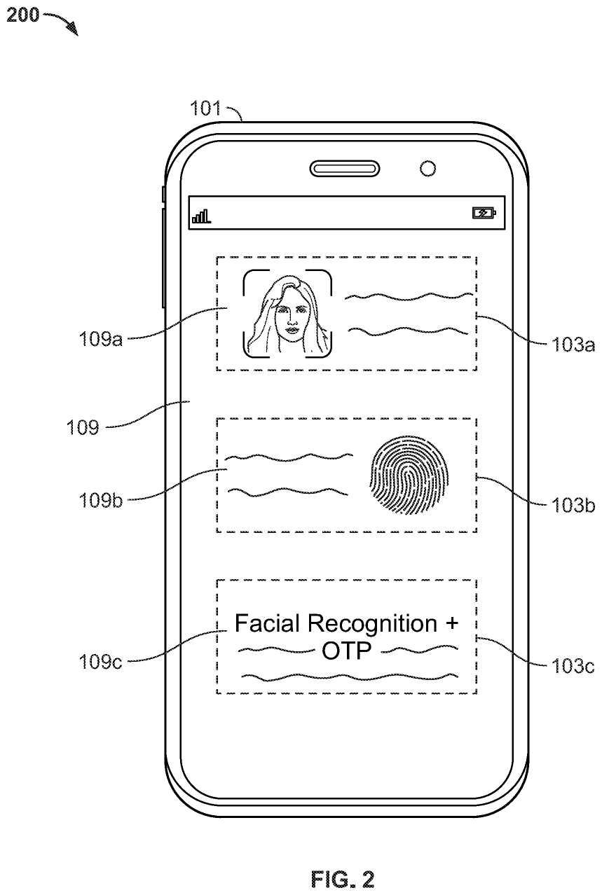

FIG. 2 shows illustrative authentication process 200. Authentication process 200 shows electronic information 109 (shown in FIG. 1) displayed on device 101. Authentication application 115 has located fields (e.g., subsets) 109a, 109b and 109c of electronic information 109 that require authentication by a user of device 101. FIG. 2 shows that facial recognition 103a is required to authenticate field 109a. Fingerprint 103b is required to authenticate field 109b. Combination 103c, which includes an OTP and facial recognition is required to authenticate field 109c. Field 109c may represent a cumulative authentication of electronic information 109. The combination of biometric features 103a-c may define an authentication sequence.

Mobile device 101 may include hardware for capturing the biometric features needed to authenticate fields 109a-c. For example, mobile device 101 may include a camera for capturing facial recognition 103a and a fingerprint reader for capturing fingerprint 103b.

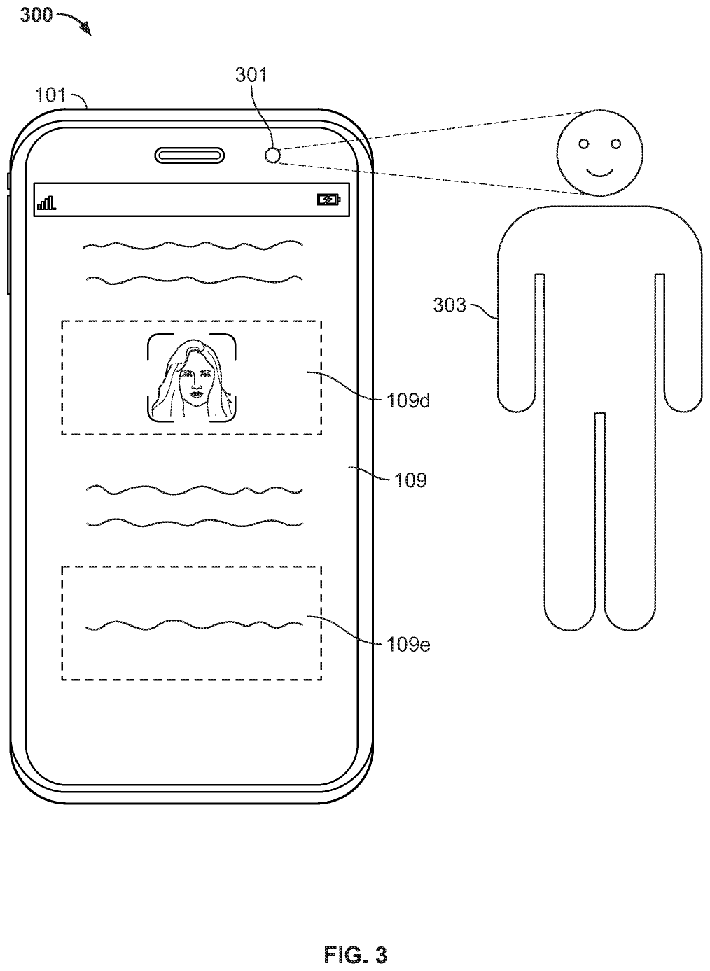

FIG. 3 shows illustrative scenario 300. Scenario 300 shows user 303 viewing electronic information 109 on device 101. Scenario 300 shows that as user 303 views displayed electronic information 109, camera 301 captures a facial scan. For example, mobile device 101 may determine when user 303 is viewing field 109d and as user 303 is viewing field 109d, camera 301 may capture a facial scan to authenticate field 109d. Mobile device 101 may determine when user 303 is viewing field 109e, and as user 303 is viewing field 109e, camera 301 may capture a facial scan to authenticate field 109e.

Mobile device 101 may determine when user 303 is viewing fields 109d-e based on where fields 109d-e are positioned on a screen of mobile device 101. Mobile device 101 may determine when user 303 is viewing fields 109d-e based using camera 301 to determine eye positions of user 303. For example, camera 300 may be able to calculate, based on a detected eye position whether user 303 is focused on field 109d or 109e. Mobile device 101 may determine when user 303 is viewing fields 109d-e based on touch inputs provided by user 303 as electronic information 109 is displayed on mobile device 101.

In some embodiments, mobile device 101 may not determine specifically which field of electronic information 109 is being viewed by user 303. Mobile device 101 may capture facial scans at intervening time intervals. Capturing two or more biometric features at different times may reduce a possibility of receiving a spoofed authentication. The time interval between a first facial scan and a second facial scan may be random assigned by mobile device 101 and authentication application 115.

Scenario 300 shows that authentication of electronic information 109 may be seamless and non-obtrusive to user 303. Mobile device 101 may be configured to capture target biometric features needed to authenticate electronic information 109 without prompting user 303 to submit the target biometric feature.

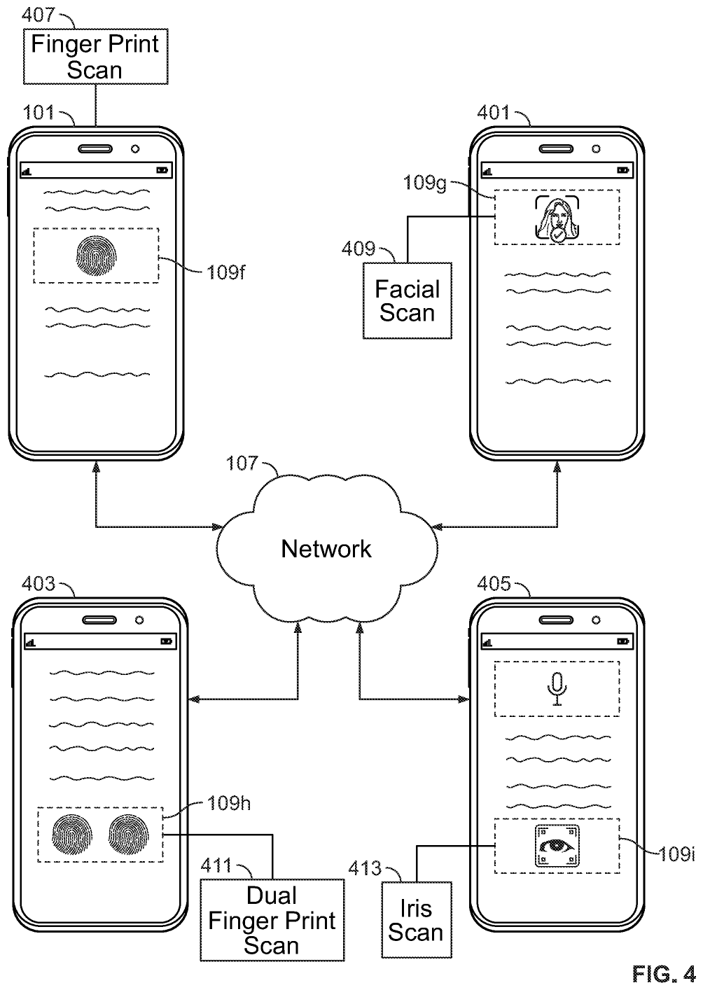

FIG. 4 shows illustrative scenario 400. Scenario 400 shows that electronic information 109 may require authentication from multiple users. A target biometric feature required by each user may be determined by an instance of authentication application 115 running on each of mobile devices 101, 401, 403 and 405. The target biometric feature may be determined based on a location of mobile device, device capability, content of the field being authenticated or any suitable criteria.

Scenario 400 shows device 101 providing fingerprint scan 407 to authenticate field 109f. Scenario 400 shows device 401 providing facial scan 409 to authenticate field 109g. Scenario 400 shows device 403 providing a dual-fingerprint scan 411 to authenticate field 109h.

Dual-fingerprint scan 411 may include a combination or sequence of fingerprints. For example, an illustrative combination may require that device 403 to capture fingerprints from a user's right thumb and right index finger. An illustrative sequence may require device 403 to capture the user's right index fingerprint before capturing the right thumb fingerprint.

Scenario 400 shows device 405 providing an iris scan 413 to authenticate field 109i. Each of the target biometric features captured by mobile devices 101, 401, 403 and 405 may be validated by the corresponding mobile device that captured the target biometric feature. In some embodiments, the captured target biometric feature may be submitted to remote computer system 113 for validation. In some embodiments, an instance of the authentication application 115 may report to remote computer system 113 that the captured target biometric feature has been validated.

Remote computer system 113 may ensure that all of fields 109f-i are associated with a valid target biometric feature. When all of fields 109f-i are associated with a valid target biometric feature, remote computer system 113 may save electronic information 109 in database 111 with an indicator noting that electronic information has been authenticated. After electronic information 109 has been authenticated, remote computer system 113 or other systems may execute transaction instructions based on the authentication of electronic information 109.

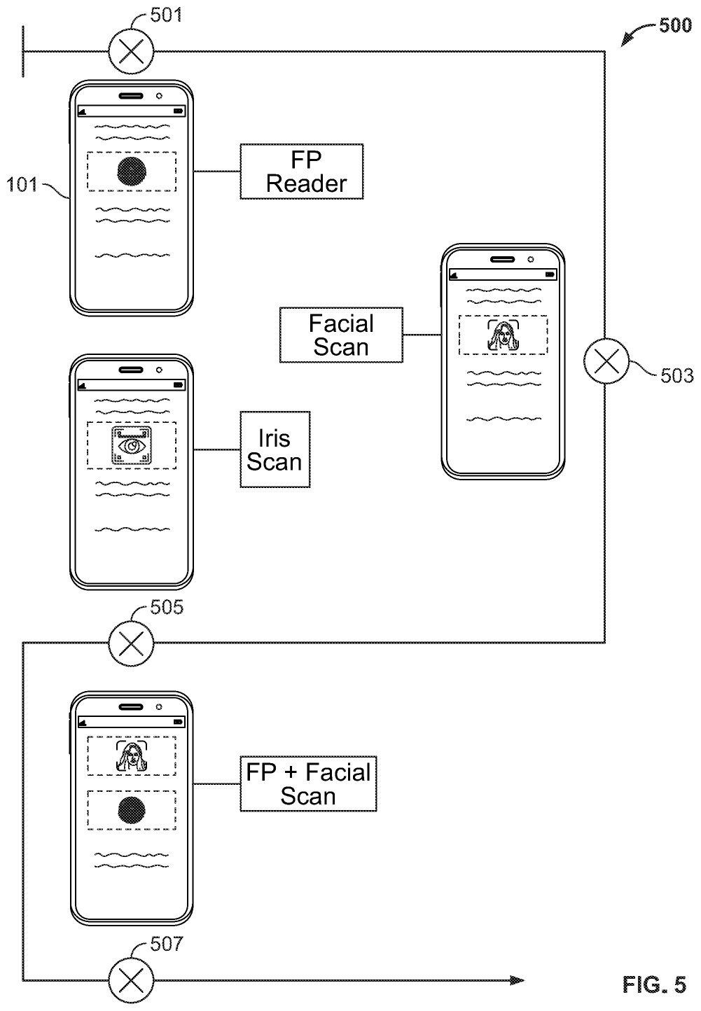

FIG. 5 shows illustrative scenario 500. Scenario 500 shows movement of mobile device 101 from location 501 to location 503 to location 505 to location 507. Scenario 500 shows that at each location, a different target biometric feature is required to authenticate information displayed at the location. The target biometric feature required at a location may be determined based on biometric features that may be accurately and conveniently captured at a particular location. The target biometric feature may be determined based on any suitable attribute of a particular location. The target biometric feature may be determined based on any content of the electronic information.

The target biometric feature required at each location may be used to authenticate different fields of electronic information 109 displayed on a mobile device. The target biometric feature required at each location may be used to authenticate a different field of electronic information displayed at each location. The very fact that mobile device 101 is in motion may itself be a reason for a different biometric feature to be required at each location.

The specific target biometric feature required at each location may be determined based on a distance separating a current location from a prior location. The motion of the mobile device may itself be a biometric feature. For example, an illustrative biometric feature may include velocity, acceleration and/or walking gait.

Scenario 500 shows that at location 501, mobile device 101 requires a fingerprint as the target biometric feature. Scenario 500 shows that at location 503, mobile device 101 requires a facial scan as the target biometric feature. Scenario 500 shows that at location 505, mobile device 101 requires an iris scan as the target biometric feature. Scenario 500 shows that at location 507, mobile device 101 requires a combination of a fingerprint and a facial scan as the target biometric feature. The requirement to provide the combination may be determined based on one or more of location 507 and the field of electronic information 109 being authenticated.

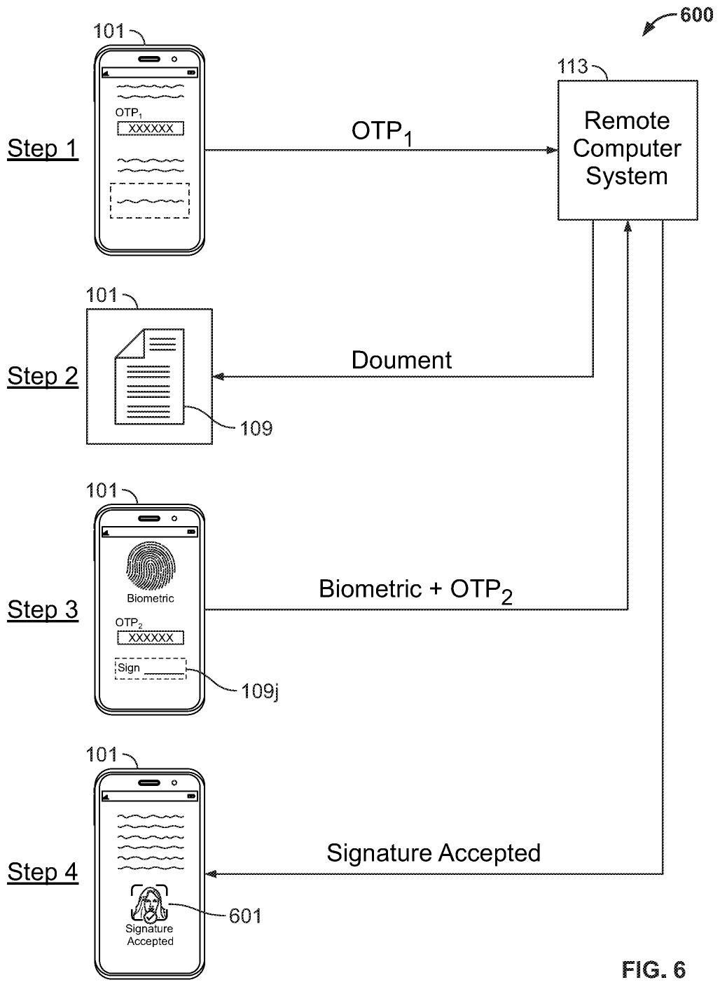

FIG. 6 shows illustrative authentication process 600. Authentication process begins at step 1. At step 1, mobile device 101 generates first OTP₁ using a token secured locally on mobile device 101. Mobile device 101 submits OTP₁ to remote computer system 113. Remote computer system 113 may validate the OTP₁ received from mobile device 101. Validation of the OTP₁ may confirm that mobile device 101 is authorized to view and authenticate electronic information 109.

At step 2, remote computer system 113 provides mobile device 101 access to electronic information 109. In some embodiments, remote computer system 113 may transmit a copy of electronic information 109 to mobile device 101. In some embodiments, remote computer system 113 may authorize mobile device 101 to access a copy of electronic information 109 stored in database 111.

Authentication process 600 may include formatting electronic information 109 for display on mobile device 101. Such formatting may include changing operation mobile device 101 to display the electronic information 109. The change in operation may include altering the luminosity of a screen on mobile device 101, altering the size of text characters displayed on the screen, and temporally terminating communication between mobile device 101 and any other computer system. For example, while viewing electronic information 109, mobile device may not be able to browse the web or initiate/receive voice calls. Terminating communication between mobile device 101 and any other system may reduce a possibility of unauthorized authentication of electronic information 109.

At step 3, after viewing electronic information 109, a target biometric feature is submitted to authenticate field 109j. Authenticating field 109j may correspond to signing electronic information 109. At step 3, mobile device 101 generates a second OTP₂. The second OTP₂ is submitted, along with the target biometric feature to remote computer system 113. The second OTP₂ may provide an additional layer of security to confirm that the target biometric feature has been captured by mobile device 101. The second OTP₂ may provide an additional layer of security to confirm that the target biometric feature has been captured at step 3 while electronic information 109 was concurrently displayed on mobile device 101.

For example, the second OTP₂ may be generated in response to capturing the target biometric feature. In other embodiments, a biometric sensor of mobile device 101 may only be activated after generating second OTP₂. In some embodiments, the second OTP₂ may be validated by remote computer system 113 before capturing the target biometric feature.

At step 4, authentication of field 109j has been accepted by remote computer system 113. At step 4 authentication 601 has been embedded into electronic information 109. Based on embedded authentication 601, remote computer system 113 may execute transaction instruction or take other action in accordance with electronic information 109. A copy of electronic information 109 that includes embedded signature 601 may be stored in database 111.

Thus, methods and apparatus for MULTI-LAYER BIOMETRIC AUTHENTICATION are provided. Persons skilled in the art will appreciate that the present invention can be practiced by other than the described embodiments, which are presented for purposes of illustration rather than of limitation, and that the present invention is limited only by the claims that follow.

What is claimed is:

1. Apparatus for authenticating electronic information, the apparatus comprising:
a device comprising hardware that displays the electronic information; and
an application running on the device that:
generates a one-time password (“OTP”) using a token stored locally on the device; and
using the OTP, provides an authenticator access to the electronic information on the device and initiates an authentication process for the electronic information, the authentication process comprising:
formatting the electronic information for display on the device;
activating a biometric sensor of the device;
prompting the authenticator for a target biometric feature based on content of the electronic information and capability of the device;
capturing the target biometric feature submitted by the authenticator using the biometric sensor;
validating the target biometric feature submitted by the authenticator;
generating an authentication using the OTP and the target biometric feature; and
authenticating the information by embedding the authentication into the electronic information.

2. The apparatus of claim 1 wherein the application determines the target biometric feature based on:
content of each field of the electronic information that requires the authentication;
authenticator behavior; or
capabilities of the device.

3. The apparatus of claim 1 wherein the application determines the target biometric feature based on a location of the device.

4. The apparatus of claim 1 wherein:
the device comprises at least two sensors for capturing biometric features; and
the target biometric feature comprises two or more biometric features.

5. The apparatus of claim 1 wherein the target biometric feature comprises a sequence of biometrics features.

6. The apparatus of claim 1 wherein the authenticator is a first authenticator, the device a first device and the target biometric feature a first target biometric feature, the authentication process further comprising:
prompting a second authenticator for a second target biometric feature;
capturing the second target biometric feature submitted by the second authenticator using a biometric sensor of a second device;
validating the second target biometric feature submitted by the second authenticator;
generating a second authentication using a combination of the second OTP and the second target biometric feature; and
authenticating the electronic information by embedding the first and second authentications into the electronic information.

7. The apparatus of claim 1, the authentication process further comprising:
requiring a first target biometric feature for a first field of the electronic information; and
requiring a second target biometric feature for a second field of the electronic information.

8. Apparatus for authenticating electronic information, the apparatus comprising:
a mobile device comprising hardware that displays the electronic information; and
an application running on the mobile device that:
configures display properties of the mobile device for viewing a subset of the electronic information;
determines a target biometric feature for authenticating the subset of the electronic information;
captures the target biometric feature to authenticate the subset of the electronic information;
after capturing the target biometric feature, generates a one-time-password (“OTP”) using a token stored on the mobile device to authenticate the device to a remote system; and
in response to receiving validation of the OTP and target biometric feature from the remote computer system, generates a digital authentication for the subset of the electronic information using the captured target biometric feature.

9. The apparatus of claim 8 wherein the OTP is a second OTP (“sOTP”), the application:
generates a first one-time password (“fOTP”) using the token stored on the device; and
using the fOTP, locates two or more subsets of the electronic information for display on the device; and
initiates a discrete authentication process for each of the subsets.

10. The apparatus of claim 8 wherein the authentication process independently determines the target biometric feature for each subset.

11. The apparatus of claim 8, wherein the device is a first device and the subset a first subset, the remote system is configured to coordinate:
authentication of a first subset of the electronic information using the first device; and
authentication of a second subset of the electronic information using a second device.

12. The apparatus of claim 11, wherein the first device uses a first OTP to access the first subset of electronic information and the second device uses a second OTP to access the second subset of the electronic information.

13. The apparatus of claim 8, wherein the target biometric feature requested by the remote computer system is determined based on a capability of the device.

14. The apparatus of claim 8, wherein the target biometric feature requested by the remote computer system is determined based on content of the electronic information.

15. The apparatus of claim 8, wherein the target biometric feature comprises a combination of two or more biometric features.

16. The apparatus of claim 8, wherein the target biometric feature requested by the remote computer system is determined by a creator of the electronic information.

17. The apparatus of claim 8, wherein the target biometric feature is randomly selected by the remote computer system from a group of biometric features that are capable of being captured by the device.

18. A method of authenticating electronic information, the method comprising:
generating a one-time password using a token stored on a device;
based on the OTP, displaying the electronic information on the device;
as the electronic information is viewed on the device, capturing a target biometric feature of the viewer; and
using the captured target biometric feature to authenticate the electronic information.

19. The method of claim 18 further comprising, determining the target biometric feature based on the OTP.

20. The method of claim 18 wherein the OTP is a first OTP, the method further comprising:
capturing the target biometric feature;
generating a second OTP based on the captured target biometric feature in combination with the token stored on the device; and
using the captured target biometric feature and the second OTP to authenticate the electronic information.
